(19) United States
(12) Patent Application Publication
(10) Pub. No.: US 2019/0050841 A1
(43) Pub. Date: Feb. 14, 2019

(54) SYSTEM AND COMPUTER-IMPLEMENTED METHOD FOR SELECTING OPTIMAL PAYMENT INSTRUMENT

(71) Applicant: ACI WORLDWIDE CORP., Elkhorn, NE (US)

(72) Inventor: KENNETH J. CHENIS, Lunenburg, MA (US)

(73) Assignee: ACI WORLDWIDE CORP., Elkhorn, NE (US)

(21) Appl. No.: 15/671,802

(22) Filed: Aug. 8, 2017

(51) Int. Cl. G06Q 20/22; G06Q 20/40

(52) U.S. Cl. CPC G06Q 20/227; G06Q 30/0226; G06Q 20/401

(57) ABSTRACT

A system and computer-implemented method for selecting an optimal payment instrument for a particular purchaser and a particular purchase. Information for several payment instruments, selection preferences provided by the purchaser, and any additional selection information are stored in a database. Artificial intelligence selects the optimal payment instrument based on the selection preferences and the additional selection information. The preferences may be weighted to reflect a level of importance to the purchaser, and may include incentive information about, e.g., reward points, reward miles, or cash back. The additional information may include usage limitations. The selected instrument is verified with an associated payment service, a request for payment using the selected instrument is submitted, and actual payment is verified. Details of the particular purchase and of the selection of the instrument may be stored for future reference. The selection preferences may be changeable, and the additional selection information may be automatically updated.

### FIELD

The present invention relates to system and methods for selecting payment instruments for transactions, and more particularly, embodiments concern a system and computer-implemented method for using artificial intelligence to improve the selection of an optimal payment instrument based on maximizing preferences for a particular purchaser and a particular purchase.

### BACKGROUND

Traditionally, consumers carry a physical wallet containing a variety of payment instruments, such as cash, bank-issued credit cards, bank-issued debit cards, loyalty cards, etc. Similarly, merchants may have payment instruments associated with their customers. FIG. 1 (PRIOR ART) is a flowchart of steps involved in a prior art manual method 10 of selecting and using a payment instrument in a transaction. A purchaser selects a particular payment instrument for the particular transaction, as shown in 12, and enters the necessary information for using the instrument, as shown in 14. The prior system then verifies the instrument, as shown in 16. The purchaser provides proof of their identity, as shown in 18, and the prior system then verifies the identity, as shown in 20. The prior system submits the request for payment to the payment service, as shown in 22, and the payment service accepts (or declines) the payment request, as shown in 24. The payment service updates the seller's account, as shown in 26, handles errors, as shown in 28, and notifies the purchaser of the completed payment, as shown in 30.

At the time of payment, the purchaser must decide on an appropriate payment method for the transaction in progress. There is intelligence that goes into deciding which of a variety of available instruments is the best instrument to use for the given transaction. Relevant considerations may include reward points, reward miles, cash back, and/or other benefits, the nature of the particular goods or services being purchased, and the identity of the particular seller. The purchaser may manually apply rules or algorithms to help with this decision, and they generally make a good decision, but they also often fail to maximize their benefits because they simply do not know or cannot effectively consider all of the applicable benefits provided by the unchosen instruments.

The decision-making process remains much the same in spite of the growing use of electronic wallets. Consumers can make purchases using a variety of payment instruments (sans actual cash) stored in their virtual electronic wallets. However, even with all of the advances in the field of payment by electronic instruments, purchasers still have to rely on a manual process to decide on an appropriate payment instrument for a particular purchase.

Additionally, as efforts to reduce fraud increase, more emphasis is being placed on the identity of the purchaser using the payment instrument, and less on the actual payment instrument being used. However, the purchaser's identity is still manually associated with the payment instrument, which continues to make selection of the instrument a manual process. For example, a toll road may use the identity of a vehicle to charge a toll, but the consumer (i.e., the vehicle driver/owner) has to manually associate a payment instrument with the purchase.

This background discussion is intended to provide information related to the present invention which is not necessarily prior art.

### SUMMARY

Embodiments of the present invention solve the above-described and other problems and limitations by providing a system and computer-implemented method for using artificial intelligence to improve the selection of an optimal payment instrument based on maximizing preferences for a particular purchaser and a particular purchase

In a first embodiment of the present invention, a computer-implemented method may be provided for improving the selection of an optimal payment instrument for a particular purchaser and a particular purchase. The computer-implemented method may broadly comprise the following steps. Information for a plurality of payment instruments associated with the particular purchaser, one or more selection preferences provided by the particular purchaser, and additional selection information for each payment instrument may be stored in a database contained in an electronic memory element. A request to select the optimal payment instrument for the particular purchaser and the particular purchase may be received by an electronic processing element. An identity of the particular purchaser may be verified, and the database contained in the memory element may be accessed by the processing element. The optimal payment instrument may be selected from the plurality of payment instruments using artificial intelligence and based on the one or more selection preferences stored in the database, the additional selection information stored in the database, and the particular purchase. The optimal payment instrument may be verified with an associated payment service, and a request for payment for the particular purchase using the optimal payment instrument may be submitted to the associated payment service by the processing element. Fulfillment of the request for payment by the associated payment service may be verified by the processing element. A set of details of the particular purchase and of the selection of the optimal payment instrument may be stored in the database contained in the memory element, and the set of details may be communicated upon request to the particular purchaser by the processing element.

In a second embodiment of the present invention, a system may be provided for improving the selection of an optimal payment instrument for a particular purchaser and a particular purchase. The system may broadly comprise an electronic memory element and an electronic processing element. The electronic memory element may contain a database storing information for a plurality of payment instruments associated with the particular purchaser, one or more selection preferences provided by the particular purchaser, and additional selection information for each payment instrument. The processing element may be configured to receive a request to select the optimal payment instrument for the particular purchaser and the particular purchase, and to perform the following actions. An identity of the particular purchaser may be verified, and the database contained in the electronic memory may be accessed. Artificial intelligence may be used to select the optimal payment instrument from the plurality of payment instruments based on the one or more selection preferences stored in the database, the additional selection information stored in the database, and the particular purchase. The optimal payment instrument may be verified with an associated payment service, and a request for payment for the particular purchase using the optimal payment instrument may be submitted to the associated payment service. Fulfillment of the request for payment by the associated payment service may be verified. A set of details of the particular purchase and of the selection of the optimal payment instrument may be stored in the database contained in the memory element, and the set of details may be communicated to the particular purchaser upon requested.

Various implementations of the foregoing embodiments may include any one or more of the following additional features. The one or more selection preferences may include specific selection preferences regarding a particular type of payment instrument, a particular type of purchase, and/or a particular type of seller. One or more of the payment instruments may be associated with one or more incentives, and the one or more selection preferences may include a general selection preference regarding the one or more incentives. The selection preferences may be weighted to reflect a level of importance to the particular user, and the step of selecting the optimal payment instrument may include comparing the weights of the selection preferences. The step of selecting the optimal payment instrument may include maximizing a desired overall benefit reflected in the selection preferences. The additional selection information may include any limitations on using each payment instrument. The additional selection information for each payment instrument stored in the database may be periodically updated.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 (PRIOR ART) is a high-level flowchart of steps in a prior art manual method for selecting a payment instrument for a particular transaction;

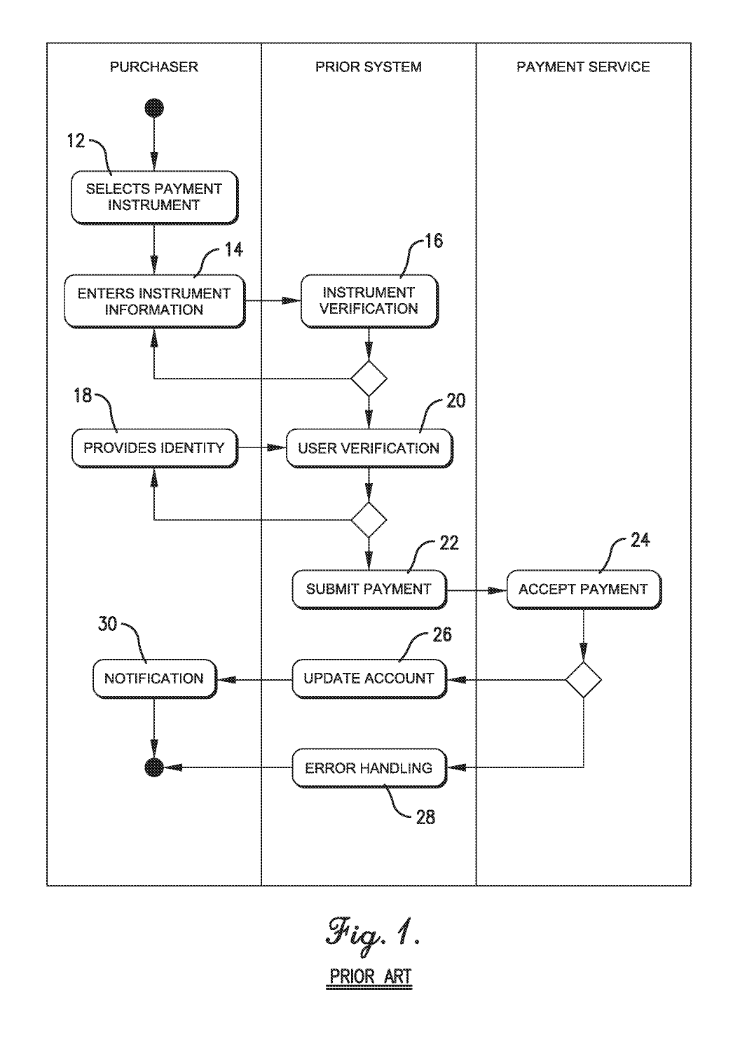

FIG. 2 is a high-level block diagram of an embodiment of a system for selecting an optimal payment instrument for a particular transaction; and

FIG. 3 is a high-level flowchart of steps in a computer-implemented method for selecting an optimal payment instrument for a particular transaction.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly characterized, the present invention provides a system and method for selecting payment instruments for transactions. More particularly, embodiments provide a system and computer-implemented method for using artificial intelligence to improve the selection of an optimal payment instrument based on maximizing preferences for a particular purchaser and a particular purchase. Embodiments advantageously allow purchasers to establish a true payment proxy for identity-based transactions, and to expect that the optimal payment instrument and associated mechanisms will be used for a particular purchase. The payment proxy may include an identity-based payment instrument selection engine, and purchasers may be allowed to initiate payments using only their identity and without having to pre-establish an association between their identity and the payment instrument for a given purchase. A particular purchaser's identity may be established based on crypto-key, third-party identity systems, or any other applicable identity instrument used to ensure an entity's identity. The payment instrument selection engine may have access to the variety of payment instruments available to the particular purchaser, and may use machine learning or other artificial intelligence principles combined with features, rules, and/or models, the selection preferences of the particular purchaser, and any additional selection information to determine the optimal payment instrument, and then initiate and verify payment using the selected instrument. These and other features and advantages are described in more detail below.

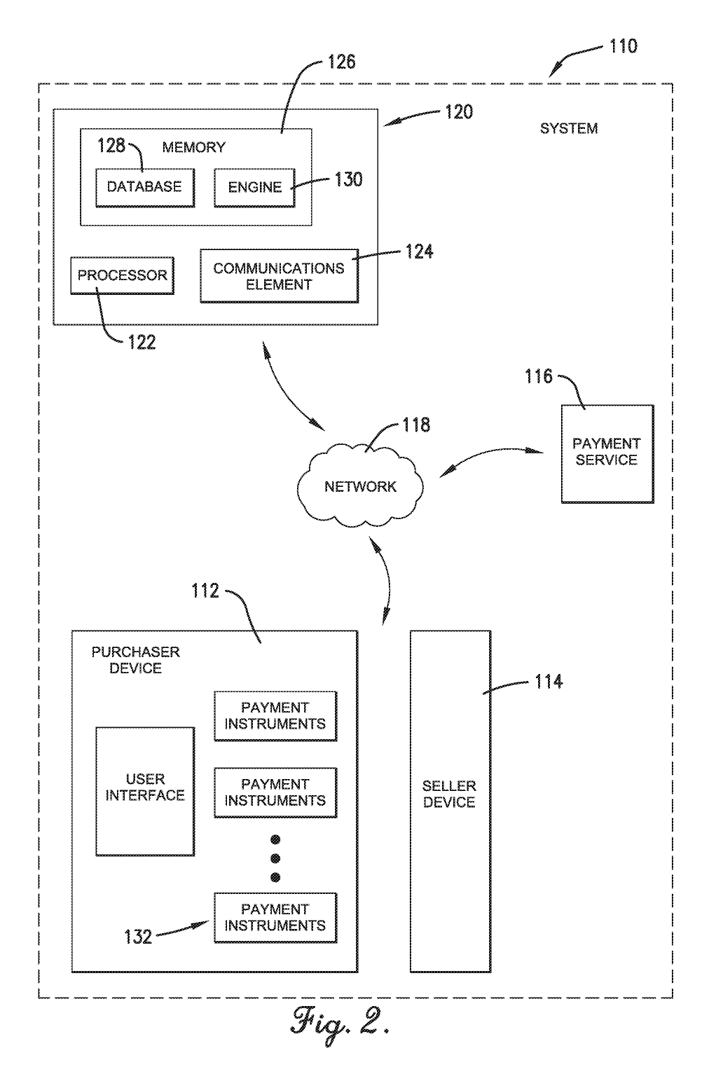

Referring to FIG. 2, an embodiment of a system 110 is shown for using artificial intelligence to improve the selection of an optimal payment instrument based on maximizing preferences for a particular purchaser and a particular purchase. The system 110 may broadly comprise a purchaser's device 112; a seller's device 114; one or more payment services 116; a communications network 118; and a computing device 120 including an electronic processing element 122, an electronic communications element 124, and an electronic memory element 126 containing a database 128 of available instruments and selection information and a payment instrument selection engine 130.

The purchaser's device 112 may be substantially any suitable non-mobile or mobile computing device, such as a desktop, laptop, or tablet computer, or a smartphone, configured to facilitate electronic transactions. The natures of the particular purchaser, the seller, and the transaction may determine or limit the nature of the purchaser's device 112. The seller's device 114 may similarly be substantially any suitable non-mobile or mobile computing device, such as a desktop, laptop, or tablet computer, or a smartphone, configured to facilitate electronic transactions. The natures of the particular purchaser, the seller, and the transaction may determine or limit the nature of the seller's device 114. The one or more payment services 116 may be substantially any suitable third-party payment service provider with which the particular purchaser has an account. For example, the particular purchaser may be associated with several payment instruments (e.g., debit cards, credit cards, lines of credit) from several different banks, in which case each bank may represent a different payment service. The communications network 118 may be substantially any suitable communication network configured to facilitate communications between the purchaser's device 112, the seller's device 114, the payment service 116, and the computing device 120 implementing the present technology.

The computing device 120 may be substantially any suitable computing device configured to implement an embodiment of the present technology, especially the process of selecting an optimal payment instrument for completing the particular purchase. The electronic processing element 122, the electronic communications element 124, and the electronic memory element 126 may each be substantially any suitable elements configured to implement aspects of the process of selecting an optimal payment instrument and requesting and verifying payment. In various implementations, the computing device 120 may be a discrete device with all of the elements incorporated into a single housing, or the computing device 120 may be a distributed device with one or more of the elements located locally and one or more of the elements located remotely with respect to the other elements.

Further, although shown in FIG. 2 for illustrative purposes as being distinct from the particular purchaser, seller, or payment service 116, the computing device 120 or any one or more components or functionalities thereof may be incorporated into the purchaser's device 112, the seller's device 114, a device associated with the payment service 116, or a device associated with a third-party service provider providing the payment instrument selection service described herein.

The database 128 of available payment instruments and selection information may be stored in the memory element 126 and accessible by the processing element 124 as needed. Broadly, the database 128 may contain for each of a plurality of different purchasers, including the particular purchaser, information regarding a plurality of payment instruments, one or more general and/or specific selection preferences, and any additional selection information.

The selection engine 130 may be stored in the memory element 126 and executed by the processing element 124 as needed. The selection engine 130 may involve artificial intelligence, which, as used herein, is broadly defined as a non-human decision-making process. Thus, the selection engine 130 may use deep learning, representation learning, automated reasoning, and/or machine learning, or any combination thereof, and/or substantially any other suitable form or characterization of artificial intelligence.

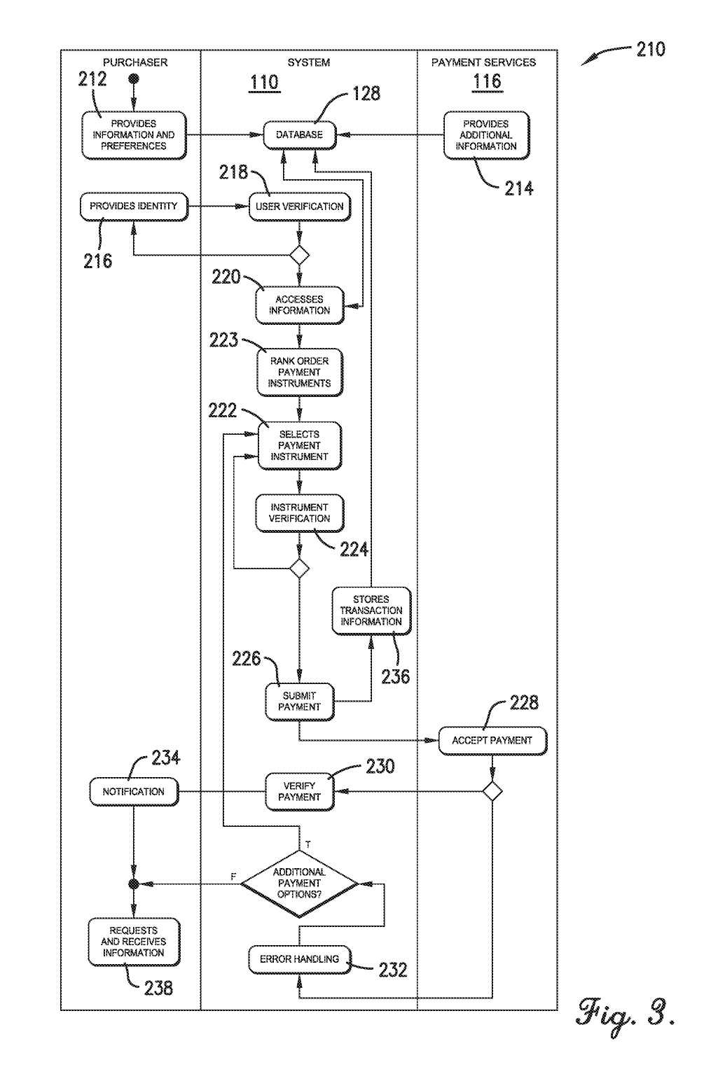

Referring also to FIG. 3, the system 110 may broadly function substantially as follows, with additional and/or alternative functionality described below in the discussion of the computer-implemented method. Information for a plurality of payment instruments associated with the particular purchaser, one or more selection preferences provided by the particular purchaser, and additional selection information for each payment instrument may be received and stored in the database 128 contained in the memory element 126, as shown in 212 and 214. The processing element 124 may receive a request to select the optimal payment instrument for the particular purchaser and the particular purchase, and in response, the processing element 124 may execute the selection engine 130 to take the following actions. An identity of the particular purchaser may be verified, as shown in 218, and the database 128 contained in the memory element 126 may be accessed, as shown in 220.

Artificial intelligence incorporated into the selection engine 130 may be used to select the optimal payment instrument from the plurality of payment instruments based on the one or more selection preferences stored in the database 128, the additional selection information stored in the database 128, and the particular purchase, as shown in 222. The optimal payment instrument may be verified with the associated payment service 116, as shown in 224, and a request for payment for the particular purchase using the optimal payment instrument may be submitted to the associated payment service 116, as shown in 226. Fulfillment of the request for payment by the associated payment service 116 may be verified, as shown in 230. A set of details of the particular purchase and of the selection of the optimal payment instrument may be stored in the database 128, as shown in 236, and the set of details may be communicated to the particular purchaser upon request, as shown in 238.

The system 110 may include more, fewer, or alternative components and/or perform more, fewer, or alternative actions, including those discussed elsewhere herein, and particularly those discussed below in describing the computer-implemented method.

Referring again to FIG. 3, an embodiment is shown of a computer-implemented method 210 for using artificial intelligence to improve the selection of an optimal payment instrument based on maximizing preferences for a particular purchaser and a particular purchase. The computer-implemented method 210 may be a corollary to the functionality of the system 110 of FIG. 2, and may be similarly implemented using the various components of the system 110 within the above-described exemplary operating environment. The computer-implemented method 210 may broadly comprise the following steps.

Initially, the particular purchaser may provide information (e.g., account numbers, PIN codes) for a plurality of payment instruments and may provide general and/or specific selection preferences relevant to selecting the optimal payment instrument for the particular purchase, as shown in 212. The selection preferences may include specific selection preferences regarding, e.g., a particular type of payment instrument, a particular type of purchase, and/or a particular type of seller. One or more of the payment instruments may be associated with one or more incentives for using them, such as reward points, reward miles, or cash back, and the selection preferences may include a general selection preference regarding these incentives. For example, a general preference may be to maximize reward points. Specific selection preferences may override general selection preferences and/or general selection rules in the selection process. The selection preferences may be weighted to reflect a level of importance to the particular user. For example, reward points may be preferred over (i.e., weighted heavier than) reward miles, and reward miles may be preferred over cash back. Some or all of this information may be input via the purchaser's device 112, communicated via the communications network 118, and stored in the database 128 in the memory element 126. The particular purchaser may update or otherwise change the payment instrument and/or selection preference information as desired using a user interface provided on the purchaser's device 112.

The payment instrument selection engine 130 may obtain additional selection information for each of the payment instruments, as shown in 214, such as usage limitations, reward benefits, and reward limitations. The additional selection information may further include selection information associated with the particular seller. Some or all of this information may be obtained from the one or more payment services 116 associated with the payment instruments, communicated via the communications network 118, and stored in the database 128 in the memory element 126. This step may be repeated continuously or periodically (e.g., at fixed intervals of once per hour, once per day, once per week), or at the initiation of the seller and/or payment service 116 in order to have recent information on which to base selection decisions.

Thereafter, when a payment is required, the particular purchaser provides proof of their identity to the system 110, as shown in 216. The proof may take substantially any suitable form, such as crypto-key, biometrics, third-party entity, traditional identity card, and may be input via, resident on, or associated with the purchaser's device 112, and communicated via the network 118 to the selection engine 130. The system 110 may verify the particular purchaser's identity, as shown in 218, and access the particular purchaser's information in the database 128, as shown in 220, including the a plurality of payment instruments, the preferences information, and the additional selection information. The selection engine 130 may use artificial intelligence to, based on the information in the database 128, select the optimal payment instrument from the plurality of payment instruments associated with the particular purchaser, as shown in 222. In general, the selection engine 130 may select the optimal payment instrument based on maximizing a desired overall benefit reflected in the one or more selection preferences.

In one implementation, the selection engine 130 may rank order the plurality of payment instruments based on optimality (i.e., from most to least optimal) for making the particular payment, as shown in 223. The selection engine may then select the most optimal payment instrument for the attempt to make the payment. However, if payment using the most optimal payment instrument fails for some reason (e.g., declined by the seller, declined by the payment service 116), then the selection engine 130 may select the next most optimal payment instrument in the rank order of payment instruments and again attempt to make the payment. This process may continue until the system 110 finds the highest rank payment instrument with which payment can be successfully accomplished.

The system 110 may verify the selected optimal payment instrument with the associated payment service 116, as shown in 224, and submit the request for payment using the optimal payment instrument to the particular payment service 116, as shown in 226. The system 110 may process this request for payment using an appropriate scheme associated with, provided by, or otherwise acceptable to the particular payment service 116. The payment service 116 may fulfill the request for payment, as shown in 228, and the system 110 may verify that the payment has been made, as shown in 230, and as necessary, handle any errors, as shown in 232. The system 110 may notify the particular purchaser via the purchaser's device 112 of the completed payment, as shown in 234. The notification may indicate the payment instrument used.

The system 110 may store in the database 128 details of the particular purchase and/or details of the selection of the optimal payment instrument, as shown in 236. Subsequently, the particular purchaser may request and review via the user interface on the purchaser's device 112 these details for a particular transaction or group of transactions, as shown in 238.

Thus, embodiments advantageously allow purchasers to establish a true payment proxy for identity-based transactions, and to expect that the optimal payment instrument and mechanisms will be used for a particular purchase.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A computer-implemented method for improving the selection of an optimal payment instrument for a particular purchaser and a particular purchase, the computer-implemented method comprising:
storing in a database contained in an electronic memory element information for a plurality of payment instruments associated with the particular purchaser, one or more selection preferences provided by the particular purchaser, and additional selection information for each payment instrument;
receiving by an electronic processing element a request to select the optimal payment instrument for the particular purchaser and the particular purchase;
verifying by the electronic processing element an identity of the particular purchaser;
accessing by the electronic processing element the database contained in the electronic memory element;
selecting using artificial intelligence the optimal payment instrument from the plurality of payment instruments based on the one or more selection preferences stored in the database, the additional selection information stored in the database, and the particular purchase;
verifying by the electronic processing element the optimal payment instrument with an associated payment service;
submitting by the electronic processing element a request for payment for the particular purchase using the optimal payment instrument to the associated payment service;
verifying by the electronic processing element that the request for payment was fulfilled by the associated payment service;
storing by the electronic processing element in the database contained in the electronic memory element a set of details of the particular purchase and of the selection of the optimal payment instrument; and
communicating by the electronic processing element the set of details to the particular purchaser upon request.

2. The computer-implemented method as set forth in claim 1, wherein the one or more selection preferences include a specific selection preference regarding a particular type of payment instrument.

3. The computer-implemented method as set forth in claim 1, wherein the one or more selection preferences include a specific selection preference regarding a particular type of purchase.

4. The computer-implemented method as set forth in claim 1, wherein the one or more selection preferences include a specific selection preference regarding a particular type of seller.

5. The computer-implemented method as set forth in claim 1, wherein one or more of the plurality of payment instruments are associated with one or more incentives, and the one or more selection preferences include a general selection preference regarding the one or more incentives.

6. The computer-implemented method as set forth in claim 5, wherein the one or more incentives are selected from the group consisting of: rewards point, reward miles, and cash back.

7. The computer-implemented method as set forth in claim 1, wherein the one or more selection preferences are weighted to reflect a level of importance to the particular user, and the step of selecting the optimal payment instrument includes comparing the weights of the one or more selection preferences.

8. The computer-implemented method as set forth in claim 1, wherein the step of selecting the optimal payment instrument includes maximizing a desired overall benefit reflected in the one or more selection preferences.

9. The computer-implemented method as set forth in claim 1, wherein the additional selection information includes any limitations on using each payment instrument.

10. The computer-implemented method as set forth in claim 1, further including the step of periodically updating the additional selection information for each payment instrument stored in the database.

11. A computer-implemented method for improving the selection of an optimal payment instrument for a particular purchaser and a particular purchase, the computer-implemented method comprising:
storing in a database contained in an electronic memory element—
information for a plurality of payment instruments associated with the particular purchaser,
one or more selection preferences provided by the particular purchaser and weighted to reflect a level of importance to the particular user, including one or more incentives associated with one or more of the payment instruments, and
additional selection information for each payment instrument, including any limitations on using each payment instrument;
receiving by an electronic processing element a request to select the optimal payment instrument for the particular purchaser and the particular purchase;
verifying by the electronic processing element an identity of the particular purchaser;
accessing by the electronic processing element the database contained in the electronic memory element;
rank ordering the plurality of payment instruments based on optimality;
selecting using artificial intelligence the optimal payment instrument from the plurality of payment instruments based on the one or more selection preferences stored in the database, the additional selection information stored in the database, and the particular purchase;
verifying by the electronic processing element the optimal payment instrument with an associated payment service;
submitting by the electronic processing element a request for payment for the particular purchase using the optimal payment instrument to the associated payment service;
if payment using the optimal payment instrument is unsuccessful, selecting a next payment instrument in the rank ordering of the plurality of payment instruments and repeating the previous steps of verifying and submitting using the next payment instrument;
verifying by the electronic processing element that the request for payment was fulfilled by the associated payment service;
storing by the electronic processing element in the database contained in the electronic memory element a set of details of the particular purchase and of the selection of the optimal payment instrument; and
communicating by the electronic processing element the set of details to the particular purchaser upon request.

12. A system for improving the selection of an optimal payment instrument for a particular purchaser and a particular purchase, the system comprising:
an electronic memory element containing a database storing information for a plurality of payment instruments associated with the particular purchaser, one or more selection preferences provided by the particular purchaser, and additional selection information for each payment instrument; and
an electronic processing element configured to receive a request to select the optimal payment instrument for the particular purchaser and the particular purchase, and to—
verify an identity of the particular purchaser,
access the database contained in the electronic memory element,
use artificial intelligence to select the optimal payment instrument from the plurality of payment instruments based on the one or more selection preferences stored in the database, the additional selection information stored in the database, and the particular purchase,
verify the optimal payment instrument with an associated payment service,
submit a request for payment for the particular purchase using the optimal payment instrument to the associated payment service,
verify that the request for payment was fulfilled by the associated payment service,
store in the database a set of details of the particular purchase and of the selection of the optimal payment instrument, and
communicate the set of details to the particular purchaser upon request.

13. The system as set forth in claim 12, wherein the one or more selection preferences include a specific selection preference regarding a particular type of payment instrument.

14. The system as set forth in claim 12, wherein the one or more selection preferences include a specific selection preference regarding a particular type of purchase.

15. The system as set forth in claim 12, wherein the one or more selection preferences include a specific selection preference regarding a particular type of seller.

16. The system as set forth in claim 12, wherein one or more of the plurality of payment instruments are associated with one or more incentives, and the one or more selection preferences include a general selection preference regarding the one or more incentives.

17. The system as set forth in claim 12, wherein the one or more selection preferences are weighted to reflect a level of importance to the particular user, and selecting the optimal payment instrument includes comparing the weights of the one or more selection preferences.

18. The system as set forth in claim 12, wherein selecting the optimal payment instrument includes maximizing a desired overall benefit reflected in the one or more selection preferences.

19. The system as set forth in claim 12, wherein the additional selection information includes any limitations on using each payment instrument.

20. The system as set forth in claim 12, wherein the processing element is further configured to periodically update the additional selection information for each payment instrument stored in the database.
